(19) United States
(12) Patent Application Publication
(10) Pub. No.: US 2016/0218359 A1
(43) Pub. Date: Jul. 28, 2016

(54) POSITIVE ELECTRODE ACTIVE MATERIAL, PREPARING METHOD THEREOF, AND LITHIUM SECONDARY BATTERY EMPLOYING POSITIVE ELECTRODE COMPRISING POSITIVE ELECTRODE ACTIVE MATERIAL

(71) Applicant: SAMSUNG SDI CO., LTD., Yongin-si (KR)

(72) Inventors: Doyu Kim, Yongin-si (KR); Mi-Ran Song, Yongin-si (KR); Jinhyoung Seo, Yongin-si (KR); Naleum Yoo, Yongin-si (KR)

(21) Appl. No.: 14/997,952

(22) Filed: Jan. 18, 2016

(30) Foreign Application Priority Data
Jan. 22, 2015 (KR) 10-2015-0010549

(51) Int. Cl. H01M 4/485; H01M 10/0525; H01M 4/36

(52) U.S. Cl. CPC H01M 4/485; H01M 4/366; H01M 10/0525; H01M 2220/20; H01M 2220/30

(57) ABSTRACT

The present disclosure relates to a positive electrode active material including a lithium composite oxide represented by Formula 1, a method of preparing the positive electrode active material, and a lithium secondary battery including the positive electrode active material.

LiₐNiₓCo_{y}M_{1-x-y-z}Al_{z}O₂ [Formula 1]

wherein in Formula 1, M may be at least one metal selected from manganese (Mn), magnesium (Mg), chromium (Cr), iron (Fe), titanium (Ti), zirconium (Zr), molybdenum (Mo), aluminum (Al), silicon (Si), and zinc (Zn), 1≦a≦1.3, x may be a number in a range of about 0.45 to about 0.6, y may be a number in a range of about 0.15 to about 0.3, and z may be a number in a range of about 0.003 to about 0.01.

### RELATED APPLICATION

Any and all applications for which a foreign or domestic priority claim is identified in the Application Data Sheet as filed with the present application are hereby incorporated by reference under 37 CFR 1.57. This application claims the benefit of Korean Patent Application No. 10-2015-0010549, filed on Jan. 22, 2015, in the Korean Intellectual Property Office, the disclosure of which is incorporated herein in its entirety by reference.

### BACKGROUND

1. Field

The present disclosure relates to a positive electrode active material, a method of preparing the same, a positive electrode including the positive electrode active material, and a lithium secondary battery employing the positive electrode.

2. Description of the Related Technology

The use of lithium secondary batteries in mobile phones, camcorders, and laptops has rapidly increased. A factor that affects the capacity of a lithium secondary battery is the positive electrode active material. Characteristics of long usability at a high rate or maintenance of initial capacity after a charging and discharging cycle may be affected according to electrochemical characteristics of the positive electrode active material.

A lithium cobalt oxide or lithium nickel manganese cobalt composite oxide may be used as the positive electrode active material in the lithium secondary battery.

There is a need for a positive electrode active material having a high charging voltage, as more and more electronic devices are employing high capacity batteries.

However, a positive electrode active material still needs improvement in terms of electrochemical characteristics due to a decrease in its lifespan or increase in gas emission, upon increasing the charging voltage.

### SUMMARY

Some embodiments include a positive electrode active material having improved electrochemical characteristics and a method of preparing the same.

Some embodiments include a lithium secondary battery employing a positive electrode including the positive electrode active material.

Additional embodiments will be set forth in part in the description which follows and, in part, will be apparent from the description, or may be learned by practice of the presented embodiments.

According to one or more exemplary embodiments, a positive electrode active material, includes a lithium composite oxide represented by Formula 1:

LiₐNiₓCo_{y}M_{1-x-y-z}Al_{z}O₂ [Formula 1]
wherein in Formula 1, M is at least one metal selected from manganese (Mn), magnesium (Mg), chromium (Cr), iron (Fe), titanium (Ti), zirconium (Zr), molybdenum (Mo), aluminum (Al), silicon (Si), and zinc (Zn);
1≦a≦1.3;
x is a number in a range of about 0.45 to about 0.6;
y is a number in a range of about 0.15 to about 0.3; and
z is a number in a range of about 0.003 to about 0.01.

According to one or more exemplary embodiments, a method of preparing a positive electrode active material including the lithium composite oxide represented by Formula 1, the method includes adding aluminum oxide and lithium carbonate to a compound represented by Formula 2 and heat-treating at about 900° C. to about 950° C.:

LiₐNiₓCo_{y}M_{1-x-y-z}Al_{z}O₂ [Formula 1]
wherein in Formula 1, M is at least one metal selected from Mn, Mg, Cr, Fe, Ti, Zr, Mo, Al, Si, and Zn;
1≦a≦1.3,
x is a number in a range of about 0.45 to about 0.6;
y is a number in a range of about 0.15 to about 0.3; and
z is a number in a range of about 0.003 to about 0.01,

NiₓCO_{y}M_{1-x-y-z}Al_{z}(OH)₂ [Formula 2]
wherein in Formula 2, M is at least one metal selected from Mn, Mg, Cr, Fe, Ti, Zr, Mo, Al, Si, and Zn;
x is a number in a range of about 0.45 to about 0.6;
y is a number in a range of about 0.15 to about 0.3; and
z is a number in a range of about 0.003 to about 0.01,
wherein M in Formulas 1 and 2 are the same.

According to one or more exemplary embodiments, a lithium secondary battery may include a positive electrode including the positive electrode active material; a negative electrode; and a separator disposed between the positive electrode and negative electrode.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 illustrates a perspective view schematically showing a cross-section of a lithium secondary battery according to an embodiment;

FIGS. 2 to 4 illustrate scanning electron microscope (SEM) images of lithium composite oxides prepared in Preparation Examples 1 and 7 and Comparative Preparation Example 3;

FIGS. 5A to 5G illustrate transmission electron microscope (TEM) images of a lithium composite oxide prepared in Preparation Example 7;

FIG. 6 illustrates energy dispersive spectroscopy (EDS) analysis results on the lithium composite oxide prepared in Preparation Example 7;

FIGS. 7A and 7B illustrate electron energy loss spectroscopy (EELS) analysis results on the lithium composite oxide prepared in Preparation Example 7;

FIGS. 8A to 8C illustrate X-ray photon spectroscopy (XPS) analysis results on the lithium composite oxides prepared in Preparation Examples 1 and 7 and Comparative Preparation Examples 1 and 3;

FIG. 9 illustrates lifespan characteristics test results at a high temperature on coin cells prepared in Example 1 and Comparative Example 1;

FIG. 10 illustrates lifespan characteristics test results on coin cells prepared in Examples 9 to 10 and Comparative Example 3;

FIG. 11 illustrates lifespan characteristics test results at a high temperature on coin cells prepared in Examples 9 to 10 and Comparative Example 4;

FIG. 12 illustrates differential scanning calorimeter (DSC) analysis results on the lithium composite oxides prepared in Preparation Example 5 and Comparative Preparation Example 1;

FIG. 13 illustrates gas emission amount test results on coin cells prepared in Example 5 and Comparative Example 1;

FIG. 14 illustrates lifespan characteristics test results at a high temperature on coin cells prepared in Example 5 and Comparative Example 1; and

FIG. 15 illustrates lifespan characteristics test results at a high temperature on coin cells prepared in Examples 1 and 12.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description.

As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” Additional aspects will be set forth in part in the description which follows and, in part, will be apparent from the description, or may be learned by practice of the presented embodiments

Hereinafter, a positive electrode active material, a method of preparing the positive electrode active material, a positive electrode including the positive electrode active material, and a lithium secondary battery including the positive electrode according to one or more exemplary embodiment will be described in detail.

The instant positive electrode active material, including a lithium composite oxide, is represented by Formula 1:

LiₐNiₓCo_{y}M_{1-x-y-z}Al_{z}O₂ [Formula 1]
wherein in Formula 1, M may be at least one metal selected from manganese (Mn), magnesium (Mg), chromium (Cr), iron (Fe), titanium (Ti), zirconium (Zr), molybdenum (Mo), aluminum (Al), silicon (Si), and zinc (Zn);
1≦a≦1.3;
x may be a number in a range of about 0.45 to about 0.6;
y may be a number in a range of about 0.15 to about 0.3; and
z may be a number in a range of about 0.003 to about 0.01.
M may be Mn.

In Formula 1, z may be, for example, in a range of about 0.005 to about 0.01; x may be in a range of about 0.5 to about 0.55; and y may be in a range of about 0.2 to about 0.25.

The lithium composite oxide represented by Formula 1 may be, for example, Li_{1.05}Ni_{0.55}Co_{0.25}Mn_{0.195}Al_{0.005}O₂, Li_{1.05}Ni_{0.55}Co_{0.25}Mn_{0.19}Al_{0.01}O₂, Li_{1.05}Ni_{0.5}Co_{0.2}Mn_{0.295}Al_{0.005}O₂, or Li_{1.05}Ni_{0.5}Co_{0.2}Mn_{0.29}Al_{0.01}O₂.

An average particle diameter of primary particles of the lithium composite oxide may be in a range of about 0.5 μm to about 2.0 μm. When an average particle diameter of a lithium composite oxide is within this range, a lithium secondary battery may have excellent lifespan characteristics when the lithium secondary battery operates at a high voltage.

In some embodiments, the positive electrode active material was analyzed by performing X-ray diffraction (XRD) analysis. A full width at half maximum (FWHM) of an angle of diffraction 2θ corresponding to a (110) face is observed in a range of about 0.139 to about 0.143, a FWHM of an angle of diffraction 2θ corresponding to a (116) face is observed in a range of about 0.114 to about 0.117. The FWHMs thereof are less than those of an angle of diffraction 2θ corresponding to a (110) face and a (116) face of a positive electrode active material doped with aluminum. Based on the FWHM ranges, it was found that the positive electrode active material is a highly crystalline material.

At least one surface of the lithium composite oxide may further contain a coating film containing lithium aluminate (LiAlO₂). When the coating film containing LiAlO₂ is included in the lithium composite oxide, lifespan characteristics may further be improved.

The coating film may have a thickness of about 1 nm to about 50 nm, for example, about 5 nm to about 15 nm. Here, the coating film may be a continuous film or a discontinuous film such as a film of an island type.

An amount of the LiAlO₂ may be in a range of about 0.1 part by weight to about 30 parts by weight based on 100 parts by weight of the lithium composite oxide represented by Formula 1, for example, about 0.3 part by weight to about 10 parts by weight. When an amount of lithium aluminate (LiAlO₂) is within this range, a lithium secondary battery may have excellent lifespan characteristics at a high voltage.

Hereinafter, a method of preparing the positive electrode active material will be described.

The lithium composite oxide represented by Formula 1 may be obtained, first, by adding aluminum oxide and lithium carbonate (Li₂CO₃) to a compound represented by Formula 2 and heat-treating at about 900° C. to about 950° C.

LiₐNiₓCo_{y}M_{1-x-y-z}Al_{z}O₂ [Formula 1]
wherein in Formula 1, M may be at least one metal selected from Mn, Mg, Cr, Fe, Ti, Zr, Mo, Al, Si, and Zn;
1≦a≦1.3;
x may be a number in a range of about 0.45 to about 0.6;
y may be a number in a range of about 0.15 to about 0.3; and
z may be a number in a range of about 0.003 to about 0.01.

NiₓCO_{y}M_{1-x-y-z}Al_{z}(OH)₂ [Formula 2]
wherein in Formula 2, M may be at least one metal selected from Mn, Mg, Cr, Fe, Ti, Zr, Mo, Al, Si, and Zn;
x may be a number in a range of about 0.45 to about 0.6;
y may be a number in a range of about 0.15 to about 0.3; and
z may be a number in a range of about 0.003 to about 0.01;
wherein M in Formulas 1 and 2 are the same.

When the heat-treatment is performed within this temperature range, a lithium composite oxide may have an excellent average diameter of primary particles and degree of crystallinity.

The heat-treatment may be performed, for example, under an oxygen atmosphere or atmospheric conditions.

When preparing the compound represented by Formula 2, aluminum oxide may be used as an aluminum source. The aluminum oxide may be, for example, γ-alumina. When γ-alumina is used, a lithium secondary battery may have an improved standard capacity and high temperature lifespan characteristics, compared to a lithium secondary battery using α-alumina.

An average diameter of the aluminum oxide may be, for example, in a range of about 0.1 μm to about 5 μm, particularly, about 0.3 μm. When such aluminum oxide is used for the compound represented by Formula 2, a positive electrode active material may have improved lifespan characteristics at room temperature and a high temperature.

The amount of aluminum oxide and lithium carbonate in the above preparation is stoichiometrically controlled so as to obtain the lithium composite oxide represented by Formula 1.

The compound represented by Formula 2 may be obtained by the following process:

First, a nickel precursor, a cobalt precursor, a metal precursor, and a solvent may be mixed in order to obtain a precursor mixture.

A pH adjusting agent may be added to the precursor mixture, and it may undergo a reaction under an inert gas atmosphere at about 40° C. to about 50° C. Once the reaction was complete, a precipitate may be obtained from the resulting mixture. The obtained precipitate may be washed, removed the water, and then dried, thereby obtaining the compound represented by Formula 2.

The inert gas atmosphere may include an inert gas, for example, nitrogen, argon, or helium.

The nickel precursor may include, for example, nickel sulfate, nickel nitrate, and nickel chloride, and examples of the cobalt precursor include cobalt sulfate, cobalt nitrate, and cobalt chloride.

The metal precursor may be a sulfate, nitrate, or chloride including at least one selected from Mn, Mg, Cr, Fe, Ti, Zr, Mo, Al, Si, and Zn. The metal precursor may be, for example, a manganese precursor. Examples of the manganese precursor include manganese sulfate, manganese nitrate, and manganese chloride.

The amount of the nickel precursor, the manganese precursor, and the cobalt precursor may be stoichiometrically controlled in order to obtain the compound represented by Formula 2. The pH adjusting agent may be any pH adjusting agent capable of adjusting the pH of the precursor mixture. Examples of the pH adjusting agent may include a sodium hydroxide solution and ammonia water.

A pH of the precursor mixture may be controlled in a range of about 12.0 to about 12.4, for example, about 12.2 to about 12.3 by varying the amount of the pH adjusting agent.

A precipitate may be obtained from the result of the above process, and the precipitate is washed with water, and then, dried, thereby obtaining the compound represented by Formula 2.

The solvent may be any solvent capable of dissolving or dispersing the nickel precursor, cobalt precursor, and metal precursor. Examples of the solvent include alcohol and water. Here, examples of the alcohol include ethanol, methanol, butanol, and iso-propanol.

The amount of the solvent may be in a range of about 100 parts by weight to about 2000 parts by weight, for example, about 110 parts by weight to about 120 parts by weight, based on 100 parts by weight of the nickel precursor. When the amount of the solvent is within this range, a mixture of which ingredients are homogeneously mixed may be obtained.

In some embodiments, there is provided a lithium secondary battery including the positive electrode active material. The lithium secondary battery has improved lifespan characteristics and stability in a voltage range of about 2.8 V to about 4.5 V, for example, and in a high voltage range of about 4.3 V to about 4.5 V at room temperature and a high temperature. The high temperature is a temperature in a range of about 40° C. to about 80° C.

Hereinafter, a method of preparing a lithium secondary battery using the positive electrode active material and a method of preparing a lithium secondary battery will be described, which battery includes a positive electrode, a negative electrode, a lithium salt-containing non-aqueous electrolyte, and a separator according to an exemplary embodiment.

A positive electrode and a negative electrode may each be prepared by coating a composition for forming a positive electrode active material layer and a composition for forming a negative electrode active material layer on a current collector, and then, drying the composition for forming a positive electrode active material layer and the composition for forming a negative electrode active material layer. The composition for forming a positive electrode active material layer may be prepared by mixing a positive electrode active material, a conducting agent, a binder, and a solvent. Here, the lithium composite oxide represented by Formula 1 may be used as a positive electrode active material.

The binder is a component that enhances binding strength between an active material and a conducting agent and binding strength to a current collector, where the amount of the binder is in a range of about 1 part by weight to about 50 parts by weight based on 100 parts by weight of the total weight of the instant positive electrode active material. Examples of the binder include polyvinylidene fluoride, polyvinyl alcohol, carboxymethyl cellulose (CMC), starch, hydroxypropyl cellulose, reproduced cellulose, polyvinylpyrrolidone, tetrafluoroethylene, polyethylene, polypropylene, ethylene propylene diene terpolymer (EPDM), sulfonated EPDM, styrene butylene rubber, fluorine rubber, and polyamide-imide (PAI). The amount of the binder is in a range of about 2 parts by weight to about 5 parts by weight based on 100 parts by weight of the total weight of the instant positive electrode active material layer. When the amount of the binder is within this range, a binding strength appropriate for binding the positive electrode active material layer to the current collector is obtained.

The conducting agent may be any material that has conductivity while not generating a chemical change in the battery. Examples of the conducting agent include graphite, such as natural graphite or artificial graphite; a carbon-based material, such as carbon black, acetylene black, Ketjen black, channel black, furnace black, lamp black, or summer black; conductive fibers, such as carbon fibers or metal fibers; a metal powder of a fluorinated carbon, aluminum, or nickel; conductive whiskers, such as zinc oxide or potassium titanate; a conductive metal oxide, such as titanium oxide; and a conductive material, such as a polyphenylene derivative.

The amount of the conducting agent may be in a range of about 2 parts to about 5 parts by weight based on 100 parts by weight of the total weight of the positive electrode active material. When the amount of the conducting agent is within this range, conductivity characteristics finally obtained may be excellent.

An example of the solvent may be N-methylpyrrolidone.

The amount of the solvent may be in a range of about 1 part to about 10 parts by weight based on 100 parts by weight of the total weight of the positive electrode active material. When the amount of the solvent is within this range, a process of the positive electrode active material layer is easily carried out.

The positive electrode current collector may be generally prepared at a thickness of about 3 μm to about 500 μm. A material for the positive electrode current collector is not particularly limited as long as the material has high conductivity while not causing a chemical change in the battery. Examples of the material for the positive electrode current collector include stainless steel, aluminum, nickel, titanium, heat-treated carbon, and aluminum or stainless steel that is surface-treated with carbon, nickel, titanium, or silver. Fine bumps may be formed on a surface of the positive electrode current collector to enhance a bonding strength of the positive electrode active material. The positive electrode current collector may be used in various forms, such as a film, a sheet, a foil, a net, a porous body, a foam body, and a non-woven fabric.

Aside from a negative electrode current collector, a negative electrode active material, a binder, a conducting agent, and a solvent are mixed to prepare a composition for forming a negative electrode active material layer.

The negative electrode active material may be a material capable of intercalation and deintercalation of lithium ions. Examples of the negative electrode active material include graphite, a carbonaceous material, such as carbon, lithium metal, an alloy thereof, and a silicon oxide-based material. In some embodiments, silicon oxide may be used as a negative electrode active material.

The amount of the binder may be in a range of about 1 part by weight to about 50 parts by weight based on 100 parts by weight of the total weight of the negative electrode active material. Examples of the binder include the same binders used in preparing the positive electrode.

The amount of the conducting agent may be in a range of about 1 part by weight to about 5 parts by weight based on 100 parts by weight of the total weight of the negative electrode active material. When the amount of the conducting agent is within this range, conductivity characteristics finally obtained may be excellent.

The amount of the solvent may be in a range of about 1 part to about 10 parts by weight based on 100 parts by weight of the total weight of the negative electrode active material. When the amount of the solvent is within this range, a process of the negative electrode active material layer is facilitated.

The conducting agent and solvent may be the same material that is used in preparing the positive electrode.

The negative electrode current collector may be generally prepared at a thickness of about 3 μm to about 500 μm. A material for the negative electrode current collector is not particularly limited as long as the material has conductivity while not causing a chemical change in the battery, and examples of the material for the negative electrode current collector include copper, stainless steel, aluminum, nickel, titanium, heat-treated carbon, copper or stainless steel that is surface-treated with carbon, nickel, titanium, or silver, and an aluminum-cadmium alloy. Also, as well as a positive electrode current collector, fine bumps may be formed on a surface of the negative electrode current collector to enhance a bonding strength of the negative electrode active material, and the negative electrode current collector may be used in various forms, such as a film, a sheet, a foil, a net, a porous body, a foam body, and a non-woven fabric.

According to the above described process, a separator is disposed between the prepared positive electrode and negative electrode.

A pore diameter of the separator is in a range of about 0.01 μm to about 10 μm, and a thickness of the separator is in a range of about 5 μm to about 300 μm. In particular, the separator may be formed of, for example, an olefin-based polymer such as polypropylene or polyethylene; or a sheet or non-woven fabric formed of glass fibers. As an electrolyte, when a solid electrolyte, such as a polymer, is used, the solid electrolyte may also serve as a separator.

A lithium-salt containing non-aqueous electrolyte is formed of a non-aqueous electrolyte solution and lithium. The non-aqueous electrolyte may be a non-aqueous electrolyte solution, an organic solid electrolyte, or an inorganic solid electrolyte.

Examples of the non-aqueous electrolyte solution may be an aprotic organic solvent, such as N-methyl-2-pyrrolidinone, propylene carbonate, ethylene carbonate, butylenes carbonate, dimethyl carbonate, diethyl carbonate, gamma-butyrolactone, 1,2-dimethoxy ethane, 2-methyltetrahydrofuran, dimethylsulfoxide, 1,3-dioxolane, N,N-formamide, N,N-dimethylformamide, dioxolane, acetonitrile, nitromethane, methyl formate, methyl acetate, triesterphosphate, trimethoxymethane, a dioxolane derivative, sulfolane, methyl sulfolane, 1,3-dimethyl-2-imidazolidinone, a propylene carbonate derivative, a tetrahydrofuran derivative, ether, methyl propionate, and ethyl propionate.

Examples of the organic solid electrolyte may include a polyethylene derivative, a polyethylene oxide derivative, a polypropylene oxide derivative, a phosphate ester polymer, a polyester sulfide, a polyvinyl alcohol, and a polyvinylidene fluoride. Examples of the inorganic solid electrolyte may include a lithium nitride, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂; a halide; and a sulfate.

The lithium salt easily dissolves in the non-aqueous electrolyte, and examples of the lithium salt may include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, a lower aliphatic lithium carboxylic acid, lithium tetraphenylborate, and imide.

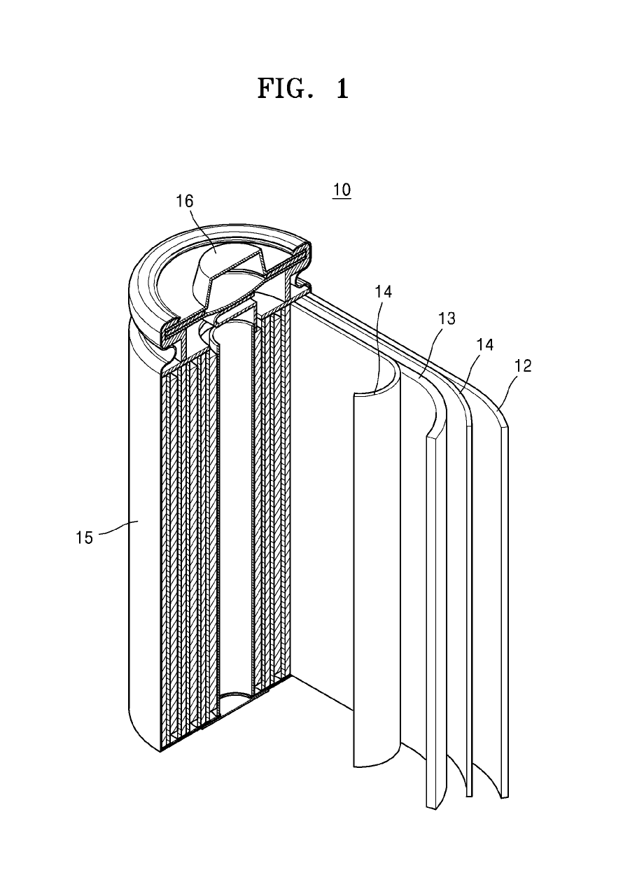

FIG. 1 is a schematic view of a lithium secondary battery 10 according to an exemplary embodiment.

Referring to FIG. 1, the lithium secondary battery 10 includes a positive electrode 13 including the lithium composite oxide, a negative electrode 12, a separator 14 disposed between the positive electrode 13 and the negative electrode 12, an electrolyte (not shown) impregnated in the positive electrode 13, the negative electrode 12, and the separator 14, a battery case 15, and a seal member 26 (not shown) sealing the battery case 15. The lithium secondary battery 10 may include the positive electrode 13, the negative electrode 12, and the separator 14 that are sequentially stacked, rolled in a spiral form, and accommodated in the battery case 15. The battery case 15 may be sealed by the cap assembly 16, thereby completing the manufacture of the lithium secondary battery 10.

The lithium secondary battery 10 is suitable for use at high power, high voltage, and high temperature, such as for electric vehicles as well as cell phones or portable computers. In addition, the lithium secondary battery 10 may be used in combination with internal combustion engines, fuel cells, or super-capacitors in hybrid vehicles, and further, may be used in devices that require high power, high voltage, and high temperature, such as E-bikes, or power tools.

Hereinafter, certain embodiments of this disclosure will be described in detail by referring to examples and comparative examples. However, the examples are presented for illustrative purposes only and do not limit the scope of the disclosure.

### PREPARATION EXAMPLE 1

### Preparation of an Example of the Instant Positive Electrode Active Material

45.5 g of Nickel sulfate, 22.1 g of cobalt sulfate, and 14.1 g of manganese sulfate were dissolved in 98.3 ml of pure water to prepare a metal sulfate solution containing nickel, cobalt, and manganese. At this point, amounts of nickel sulfate, cobalt sulfate, and manganese sulfate were stoichiometrically controlled to obtain the precursor material Ni_{0.55}Co_{0.25}Mn_{0.20}(OH)₂.

The metal sulfate solution precipitated by adjusting the pH of the metal sulfate solution to about 12.2 using a sodium hydroxide solution and ammonia water under a nitrogen atmosphere, at about 40° C. to about 50° C. The resultant precipitate was washed, the washed resultant was performed b filtration, and then dried to obtain Ni_{0.55}Co_{0.25}Mn_{0.20}(OH)₂.

In order to obtain Li_{1.05}Ni_{0.55}Co_{0.25}Mn_{0.195}Al_{0.005}O₂, 0.5 mol % of γ-aluminum oxide (Al₂O₃) (having an average diameter of about 0.3 μm) and lithium carbonate (Li₂CO₃) were added to Ni_{0.55}Co_{0.25}Mn_{0.20}(OH)₂, and mixed. Afterward, the resulting mixture was placed in a furnace at a heating rate of about 2° C./min up to 900° C. under atmospheric conditions, and then, was heat-treated at 900° C. for 5 hours to prepare a positive electrode active material of the formula Li_{1.05}Ni_{0.55}Co_{0.25}Mn_{0.195}Al_{0.005}O₂.

### PREPARATION EXAMPLE 2

### Preparation of an Example of the Instant Positive Electrode Active Material

A positive electrode active material Li_{1.05}Ni_{0.55}Co_{0.25}Mn_{0.19}Al_{0.01}O₂ was prepared in the same manner as in Preparation Example 1, except that the amount of Al₂O₃ was 1 mol %.

### PREPARATION EXAMPLE 3

### Preparation of an Example of the Instant Positive Electrode Active Material

41.4 g of Nickel sulfate, 17.7 g of cobalt sulfate, and 21.1 g of manganese sulfate were dissolved in 99.8 ml of pure water to prepare a metal sulfate solution containing nickel, cobalt, and manganese. At this point, amounts of nickel sulfate, cobalt sulfate, and manganese sulfate were stoichiometrically controlled to obtain Ni_{0.5}Co_{0.2}Mn_{0.3}(OH)₂.

The metal sulfate solution was subjected to precipitation by adjusting the pH of the metal sulfate solution to about 12.2 using a sodium hydroxide solution and ammonia water under a nitrogen atmosphere, at about 40° C. to about 50° C., and precipitates were washed, the washed resultant was performed b filtration, and then dried to obtain the precursor material Ni_{0.5}Co_{0.2}Mn_{0.3}(OH)₂.

In order to obtain Li_{1.05}Ni_{0.5}Co_{0.2}Mn_{0.295}Al_{0.005}O₂, 0.5 mol % of Al₂O₃ and Li₂CO₃ were added to Ni_{0.5}Co_{0.2}Mn_{0.3}(OH)₂, and mixed. Then, the resulting mixture was heat-treated in a furnace under atmospheric conditions at 930° C. for 5 hours to prepare a positive electrode active material of the formula Li_{1.05}Ni_{0.5}Co_{0.2}Mn_{0.295}Al_{0.005}O₂.

### PREPARATION EXAMPLE 4

### Preparation of an Example of the Instant Positive Electrode Active Material

A positive electrode active material Li_{1.05}Ni_{0.5}Co_{0.2}Mn_{0.295}Al_{0.005}O₉₅₀ was prepared in the same manner as in Preparation Example 1, except that the heat-treatment temperature was 950° C.

### PREPARATION EXAMPLE 5

### Preparation of an Example of the Instant Positive Electrode Active Material

A positive electrode active material Li_{1.05}Ni_{0.55}Co_{0.25}Mn_{0.197}Al_{0.003}O₂ was prepared in the same manner as in Preparation Example 1, except that the amount of Al₂O₃was adjusted to about 0.3 mol % so as to prepare the positive electrode active material.

### PREPARATION EXAMPLE 6

### Preparation of an Example of the Instant Positive Electrode Active Material

A positive electrode active material Li_{1.05}Ni_{0.5}Co_{0.2}Mn_{0.297}Al_{0.003}O₂ was prepared in the same manner as in Preparation Example 3, except that the amount of Al₂O₃ was adjusted to about 0.3 mol % so as to prepare the positive electrode active material.

### PREPARATION EXAMPLE 7

### Preparation of an Example of the Instant Positive Electrode Active Material

A coating film containing LiAlO₂ was formed by performing the process below, on the positive electrode active material Li_{1.05}Ni_{0.55}Co_{0.25}Mn_{0.195}Al_{0.005}O₂ prepared in Preparation Example 1. In this regard, a thickness of the coating film was about 10 nm.

First, aluminum tri-sec-butoxide and acetyl acetone were stirred at about 65° C. for about 1 hour so as to cause a reaction, and then, were diluted with anhydrous ethanol to prepare an Al₂O₃ coating solution. Here the amount of Al₂O₃ in the solution was 10 wt %.

The lithium composite oxide Li_{1.05}Ni_{0.55}Co_{0.25}Mn_{0.195}Al_{0.005}O₂ prepared in Preparation Example 1 was first dispersed in anhydrous ethanol. Then, the coating solution was added to lithium composite oxide dispersed in anhydrous ethanol, and was stirred for about 30 minutes. Then, the resulting active material slurry was stirred and dried at a range of about 100° C. to about 150° C. to prepare powder. The prepared powder was heat-treated in a furnace under atmospheric conditions at about 800° C. for 3 hours in order to obtain a positive electrode active material of the formula Li_{1.05}Ni_{0.55}Co_{0.25}Mn_{0.195}Al_{0.005}O₂ coated with a film containing LiAlO₂.

### PREPARATION EXAMPLE 8

### Preparation of an Example of the Instant Positive Electrode Active Material

A positive electrode active material having formed a coating film on Li_{1.05}Ni_{0.5}Co_{0.2}Mn_{0.295}Al_{0.005}O₂, in which the coating film contained LiAlO₂, was prepared in the same manner as in Preparation Example 7, except that Li_{1.05}Ni_{0.5}Co_{0.2}Mn_{0.295}Al_{0.005}O₂ prepared in Preparation Example 4 was used instead of Li_{1.05}Ni_{0.55}Co_{0.25}Mn_{0.195}Al_{0.005}O₂ prepared in Preparation Example 1. In this regard, a thickness of the coating film was about 10 nm.

### PREPARATION EXAMPLE 9

### Preparation of an Example of the Instant Positive Electrode Active Material

A positive electrode active material Li_{1.05}Ni_{0.5}Co_{0.2}Mn_{0.29}Al_{0.01}O₂ was prepared in the same manner as in Preparation Example 3, except that the amount of Al₂O₃ was adjusted to about 1.0 mol % so as to prepare the positive electrode active material.

### PREPARATION EXAMPLE 10

### Preparation of an Example of the Instant Positive Electrode Active Material

A positive electrode active material was prepared in the same manner as in Preparation Example 1, except that a-aluminum oxide was used instead of γ-aluminum oxide.

### COMPARATIVE PREPARATION EXAMPLE 1

### Preparation of Positive Electrode Active Material

A positive electrode active material Li_{1.05}Ni_{0.55}Co_{0.25}Mn_{0.2} was prepared in the same manner as in Preparation Example 1, except that Al₂O₃ was not added thereto.

### COMPARATIVE PREPARATION EXAMPLE 2

### Preparation of Positive Electrode Active Material

A positive electrode active material Li_{1.05}Ni_{0.50}Co_{0.20}Mn_{0.28}Al_{0.02}O₂ was prepared in the same manner as in Preparation Example 3, except that the amount of Al₂O₃ was 2 mol %.

### COMPARATIVE PREPARATION EXAMPLE 3

### Preparation of Positive Electrode Active Material

45.5 g of Nickel sulfate, 22.1 g of cobalt sulfate, and 14.1 g of manganese sulfate were dissolved in 98.3 ml of pure water to prepare a metal sulfate solution containing nickel, cobalt, and manganese. At this point, amounts of nickel sulfate, cobalt sulfate, and manganese sulfate were stoichiometrically controlled to obtain Ni_{0.55}Co_{0.25}Mn_{0.20}(OH)₂.

The metal sulfate solution was subjected to precipitation by adjusting the pH of the metal sulfate solution to about 12.2 using a sodium hydroxide solution and ammonia water under a nitrogen atmosphere, at about 40° C. to about 50° C., and precipitates were washed, water separated, and dried to obtain Ni_{0.55}Co_{0.25}Mn_{0.20}(OH)₂.

In order to obtain Li_{1.05}Ni_{0.55}Co_{0.25}Mn_{0.2}O₂, lithium carbonate was added to Ni_{0.55}Co_{0.25}Mn_{0.20}(OH)₂, and mixed. Then, the resulting mixture was heat-treated in a furnace under atmospheric conditions at 900° C. for 5 hours to prepare a positive electrode active material Li_{1.05}Ni_{0.55}Co_{0.25}Mn_{0.2}O₂.

First, aluminum tri-sec-butoxide and acetyl acetone were stirred at about 65° C. for about 1 hour so as to cause a reaction, and then, were diluted with anhydrous ethanol to prepare a Al₂O₃ coating solution. Here the amount of Al₂O₃ was 10 wt %.

The positive electrode active material Li_{1.05}Ni_{0.55}Co_{0.25}Mn_{0.2}O₂ was first dispersed in anhydrous ethanol. Then, the coating solution was added to the positive electrode active material dispersed in anhydrous ethanol, and was stirred for about 30 minutes. Then, the resulting active material slurry was stirred and dried at a range of about 100° C. to about 150° C. to prepare powder. The prepared powder was heat-treated in a furnace under atmospheric conditions at about 800° C. for 3 hours in order to obtain a positive electrode active material of the formula Li_{1.05}Ni_{0.55}Co_{0.25}Mn_{0.2}O₂ coated with a coating film containing LiAlO₂.

### COMPARATIVE PREPARATION EXAMPLE 4

### Preparation of Positive Electrode Active Material

41.4 g of Nickel sulfate, 17.7 g of cobalt sulfate, and 21.1 g of manganese sulfate were dissolved in 99.8 ml of pure water to prepare a metal sulfate solution containing nickel, cobalt, and manganese. At this point, amounts of nickel sulfate, cobalt sulfate, and manganese sulfate were stoichiometrically controlled to obtain Ni_{0.5}Co_{0.20}Mn_{0.3}(OH)₂.

The metal sulfate solution was subjected to precipitation by adjusting the pH of the metal sulfate solution to about 12.2 using a sodium hydroxide solution and ammonia water under a nitrogen atmosphere, at about 45° C., and precipitates were washed, water separated, and dried to obtain Ni_{0.5}Co_{0.2}Mn_{0.3}(OH)₂.

In order to obtain Li_{1.05}Ni_{0.5}Co_{0.2}Mn_{0.3}O₂, lithium carbonate (Li₂CO₃) was added to Ni_{0.5}Co_{0.2}Mn_{0.3}(OH)₂, and mixed. Then, the resulting mixture was heat-treated in a furnace under atmospheric conditions at 950° C. for 5 hours to prepare a positive electrode active material Li_{1.05}Ni_{0.5}Co_{0.2}Mn_{0.3}O₂.

First, aluminum tri-sec-butoxide and acetyl acetone were stirred at about 65° C. for about 1 hour so as to cause a reaction, and then, were diluted with anhydrous ethanol to prepare a Al₂O₃ coating solution. Here the amount of Al₂O₃ was 10 wt %.

The positive electrode active material Li_{1.05}Ni_{0.5}Co_{0.2}Mn_{0.3}O₂ prepared in Preparation Example 1 was first dispersed in anhydrous ethanol. Then, the coating solution was added to the positive electrode active material dispersed in anhydrous ethanol, and the resulting slurry was stirred for about 30 minutes. Then, the resulting active material slurry was stirred and dried at a range of about 100° C. to about 150° C. to prepare powder. The prepared powder was heat-treated in a furnace under atmospheric conditions at about 800° C. for 3 hours in order to obtain a positive electrode active material having formed a coating film on Li_{1.05}Ni_{0.5}Co_{0.2}Mn_{0.3}O₂, in which the coating film contained LiAlO₂.

### COMPARATIVE PREPARATION EXAMPLE 5

### Preparation of Positive Electrode Active Material

A positive electrode active material Li_{1.05}Ni_{0.55}Co_{0.25}Mn_{0.198}Al_{0.002}O₂ was prepared in the same manner as in Preparation Example 3, except that the amount of Al₂O₃ was changed adjusted so as to prepare the positive electrode active material.

### EXAMPLE 1

### Preparation of Coin Cell

A 2032 coin cell was prepared as follows using the positive electrode active material prepared in Example 1:

96 g of the positive electrode active material prepared in Example 1, 2 g of polyvinylidene fluoride, 47 g of N-methylpyrrolidone, as a solvent, and 2 g of carbon black, as a conductive agent, were mixed. Bubbles were removed from the mixture by using a mixer to obtain a slurry for forming a positive electrode active material layer that is homogeneously dispersed.

The slurry for forming a positive electrode active material layer was coated onto aluminum foil using a doctor blade to form a thin plate. The thin plate was dried at 135° C. for about 3 hours or more, pressed, and dried in a vacuum to prepare a positive electrode.

The positive electrode and a lithium metal counter electrode were used to prepare a 2032 type coin cell. A separator formed of a porous polyethylene (PE) film and having a thickness of about 16 μm was disposed between the positive electrode and the lithium metal counter electrode, and an electrolyte was injected thereto to prepare a 2032 type coin cell.

Here, the electrolyte was a solution of 1.1 M LiPF₆ dissolved in a mixed solvent of ethylene carbonate (EC) and ethyl methyl carbonate (EMC) in a volume ratio of 3:5.

### EXAMPLES 2 and 5 to 8

### Preparation of Coin Cell

A coin cell was prepared in the same manner as in Preparation Example 1, except that the positive electrode active material prepared in Examples 2 and 5 to 8 were used instead of the positive electrode active material prepared in Example 1.

### EXAMPLE 3

### Preparation of Coin Cell

A positive electrode active material was prepared by mixing LiCoO₂ and the positive electrode active material prepared in Preparation Example 3 in a weight ratio of about 8:2.

96 g of the resultant positive electrode active material from above, 2 g of polyvinylidene fluoride, 47 g of N-methylpyrrolidone, as a solvent, and 2 g of carbon black, as a conductive agent, were mixed. Bubbles were removed from the mixture by using a mixer to obtain a slurry for forming a positive electrode active material layer that is homogeneously dispersed.

The slurry for forming a positive electrode active material layer was coated onto aluminum foil using a doctor blade to form a thin plate. The thin plate was dried at 135° C. for about 3 hours or more, pressed, and dried in a vacuum to prepare a positive electrode.

A mixture of graphite powder and a PVDF binder in a weight ratio of 1:1 was prepared, as a negative electrode active material. In order to adjust the viscosity of the mixture, N-methylpyrrolidone was added thereto such that a solid content of the mixture was 60 wt %, thereby preparing a negative electrode active material slurry. The prepared slurry was coated onto a 10 μm-thick Cu foil current collector, dried, and then roll-pressed to prepare a negative electrode.

The prepared from above positive electrode, the negative electrode, and a separator (product name: STAR20, available from Asahi; Tokyo Japan) formed from polyethylene having a thickness of about 20 μm were used to form a coin cell, and the electrolyte was injected thereto to finish preparing the coin cell.

### EXAMPLE 4

### Preparation of Coin Cell

A coin cell was prepared in the same manner as in Example 3, except that the positive electrode active material prepared in Preparation Example 4 was used instead of the positive electrode active material prepared in Preparation Example 3.

### EXAMPLE 9

### Preparation of Coin Cell

LiCoO₂ and the positive electrode active material Li_{1.05}Ni_{0.55}Co_{0.25}Mn_{0.195}Al_{0.005}O₂ prepared in Preparation Example 1 were mixed in a weight ratio of about 8:2 to prepare a positive electrode active material.

96 g of the resultant positive electrode active material, 2 g of polyvinylidene fluoride, 47 g of N-methylpyrrolidone, as a solvent, and 2 g of carbon black, as a conductive agent, were mixed. Bubbles were removed from the mixture by using a mixer to obtain a slurry for forming a positive electrode active material layer that is homogeneously dispersed.

The slurry for forming a positive electrode active material layer was coated onto aluminum foil using a doctor blade to form a thin plate. The thin plate was dried at 135° C. for about 3 hours or more, pressed, and dried in a vacuum to prepare a positive electrode.

A mixture of graphite powder and a PVDF binder in a weight ratio of 1:1 was prepared, as a negative electrode active material. In order to adjust the viscosity of the mixture, N-methylpyrrolidone was added thereto such that a solid content of N-methylpyrrolidone was 60 wt %, thereby preparing a negative electrode active material slurry. The prepared slurry was coated onto a 10 μm-thick Cu foil current collector, dried, and then roll-pressed to prepare a negative electrode.

The prepared from above positive electrode, the negative electrode, and a separator (product name: STAR20, available from Asahi; Tokyo Japan) formed from polyethylene having a thickness of about 20 μm were used to form a coin cell, and the electrolyte was injected thereto to finish preparing the coin cell.

### EXAMPLE 10

### Preparation of Coin Cell

A coin cell was prepared in the same manner as in Example 9, except that the positive electrode active material prepared in Preparation Example 2 was used instead of the positive electrode active material prepared in Preparation Example 1.

### EXAMPLE 11

### Preparation of Coin Cell

A coin cell was prepared in the same manner as in Example 9, except that the positive electrode active material prepared in Preparation Example 9 was used instead of the positive electrode active material prepared in Preparation Example 1.

### EXAMPLE 12

### Preparation of Coin Cell

A coin cell was prepared in the same manner as in Example 9, except that the positive electrode active material prepared in Preparation Example 10 was used instead of the positive electrode active material prepared in Preparation Example 1.

### COMPARATIVE EXAMPLE 1

### Preparation of Coin Cell

A coin cell was prepared in the same manner as in Comparative Example 1, except that the positive electrode active material prepared in Comparative Preparation Example 1 was used instead of the positive electrode active material prepared in Preparation Example 1.

### COMPARATIVE EXAMPLE 2

### Preparation of Coin Cell

A positive electrode active material was prepared by mixing LiCoO₂ and the positive electrode active material prepared in Comparative Preparation Example 2 in a weight ratio of about 8:2.

96 g of the positive electrode active material, 2 g of polyvinylidene fluoride, 47 g of N-methylpyrrolidone, as a solvent, and 2 g of carbon black, as a conductive agent, were mixed. Bubbles were removed from the mixture by using a mixer to obtain a slurry for forming a positive electrode active material layer that is homogeneously dispersed.

The above slurry for forming a positive electrode active material layer was coated onto aluminum foil using a doctor blade to form a thin plate. The thin plate was dried at 135° C. for about 3 hours or more, pressed, and dried in a vacuum to prepare a positive electrode.

A mixture of graphite powder and a PVDF binder in a weight ratio of 1:1 was prepared to be used, as a negative electrode active material. In order to adjust the viscosity of the mixture, N-methylpyrrolidone was added thereto such that a solid content of N-methylpyrrolidone was 60 wt %, thereby preparing a negative electrode active material slurry. The prepared slurry was coated onto a 10 μm-thick Cu foil current collector, dried, and then roll-pressed to prepare a negative electrode.

The prepared from above positive electrode, the negative electrode, and a separator (product name: STAR20, available from Asahi; Tokyo Japan) formed from polyethylene having a thickness of about 20 μm were used to form a coin cell, and the electrolyte was injected thereto to finish preparing the coin cell.

### COMPARATIVE EXAMPLE 3

### Preparation of Coin Cell

A coin cell was prepared in the same manner as in Comparative Example 2, except that the positive electrode active material prepared in Comparative Preparation Example 3 was used instead of the positive electrode active material prepared in Preparation Example 2.

### COMPARATIVE EXAMPLE 4

### Preparation of Coin Cell

A positive electrode active material was prepared by mixing LiCoO₂ and the positive electrode active material prepared in Comparative Preparation Example 1 in a weight ratio of about 8:2.

96 g of the resultant positive electrode active material, 2 g of polyvinylidene fluoride, 47 g of N-methylpyrrolidone, as a solvent, and 2 g of carbon black, as a conductive agent, were mixed. Bubbles were removed from the mixture by using a mixer to obtain a slurry for forming a positive electrode active material layer that is homogeneously dispersed.

The slurry for forming a positive electrode active material layer was coated onto aluminum foil using a doctor blade to form a thin plate. The thin plate was dried at 135° C. for about 3 hours or more, pressed, and dried in a vacuum to prepare a positive electrode.

A mixture of graphite powder and a PVDF binder in a weight ratio of 1:1 was prepared, as a negative electrode active material. In order to adjust the viscosity of the mixture, N-methylpyrrolidone was added thereto such that a solid content of N-methylpyrrolidone was 60 wt %, thereby preparing a negative electrode active material slurry. The prepared slurry was coated onto a 10 μm-thick Cu foil current collector, dried, and then roll-pressed to prepare a negative electrode.

The prepared from above positive electrode, the negative electrode, and a separator (product name: STAR20, available from Asahi; Tokyo Japan) formed from polyethylene having a thickness of about 20 μm were used, and the electrolyte was injected thereto to finish preparing the a coin cell.

### COMPARATIVE EXAMPLE 5

### Preparation of Coin Cell

A coin cell was prepared in the same manner as in Comparative Example 1, except that a positive electrode active material was prepared by mixing LiCoO₂ and the positive electrode active material prepared in Comparative Preparation Example 5 in a weight ratio of about 8:2.

### EVALUATION EXAMPLE 1

### Analysis by Using Scanning Electron Microscope

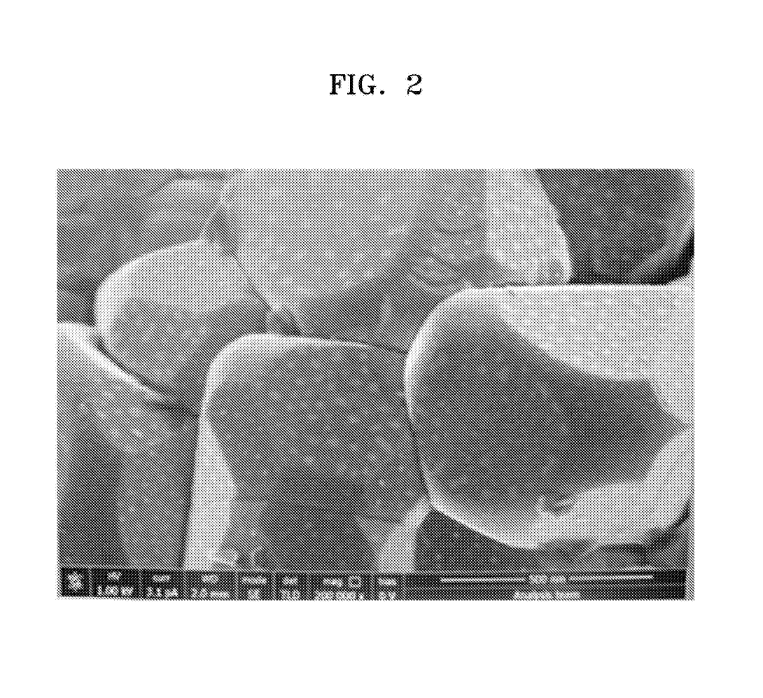

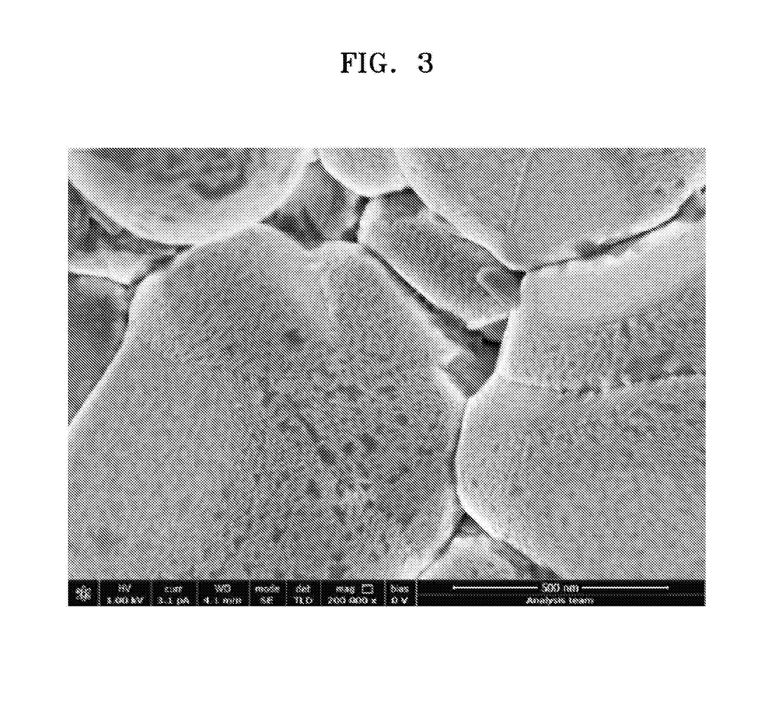

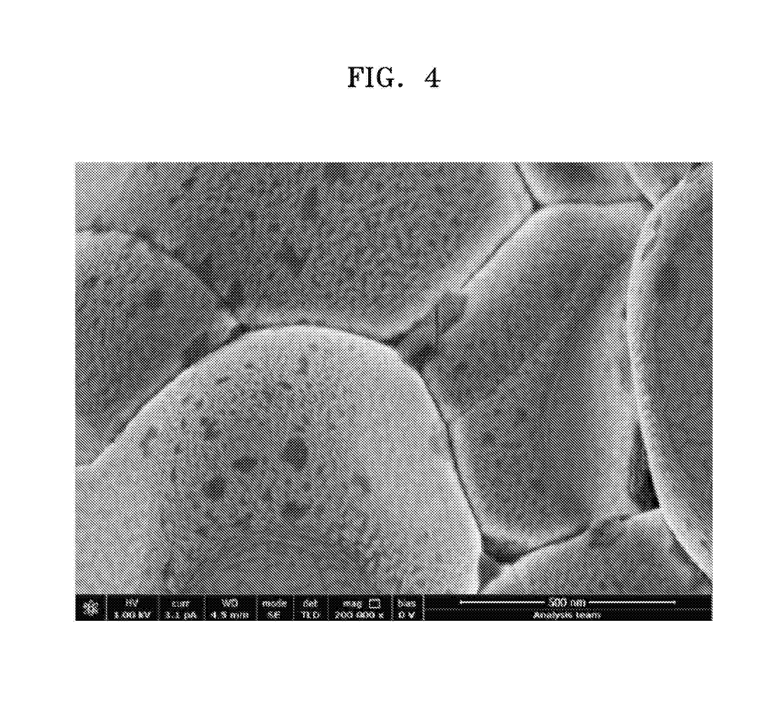

Positive electrode active materials prepared in Preparation Examples 1 and 7 and Comparative Preparation Example 3 were analyzed by using a scanning electron microscope using SEM (Magellan 400, FEI, U.S.A.). The results are shown in FIGS. 2 to 4, respectively.

Referring to FIGS. 2 to 4, it was found that the positive electrode active material prepared in Preparation Example 7 and the positive electrode active material prepared in Comparative Preparation Example 3 have coating films of which surfaces are in a homogeneous form, compared to that of the positive electrode active material prepared in Preparation Example 1.

### EVALUATION EXAMPLE 2

### Transmission Electron Microscope Analysis

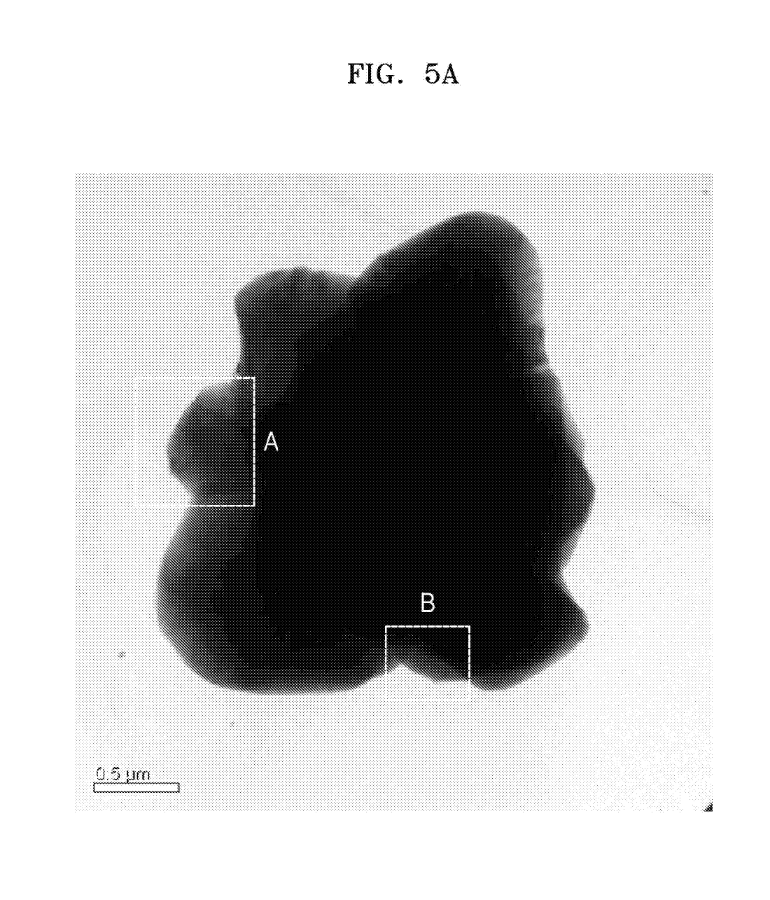

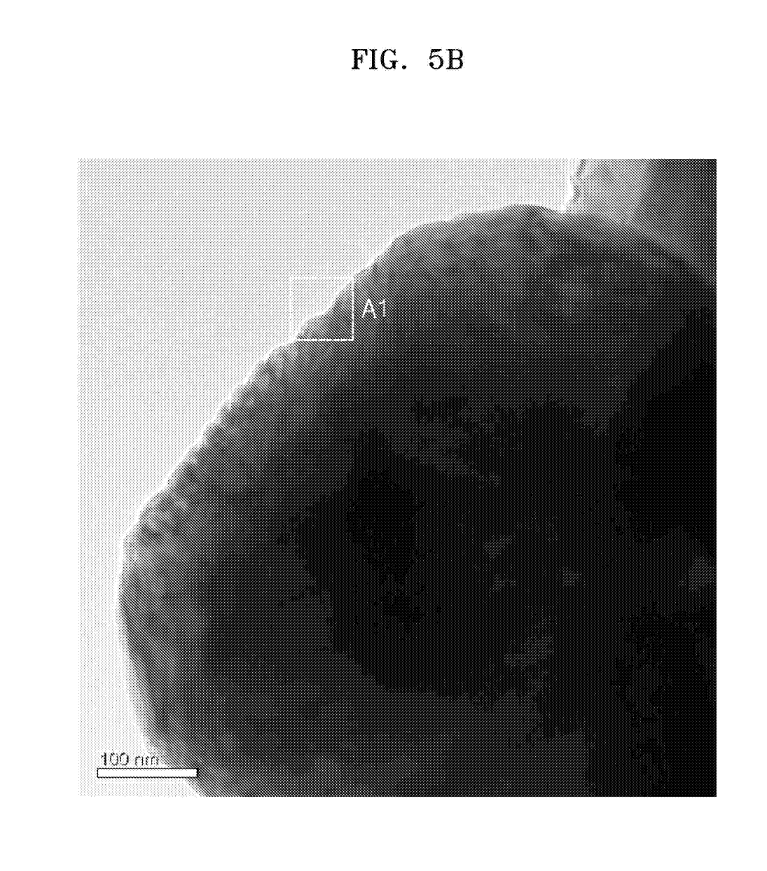

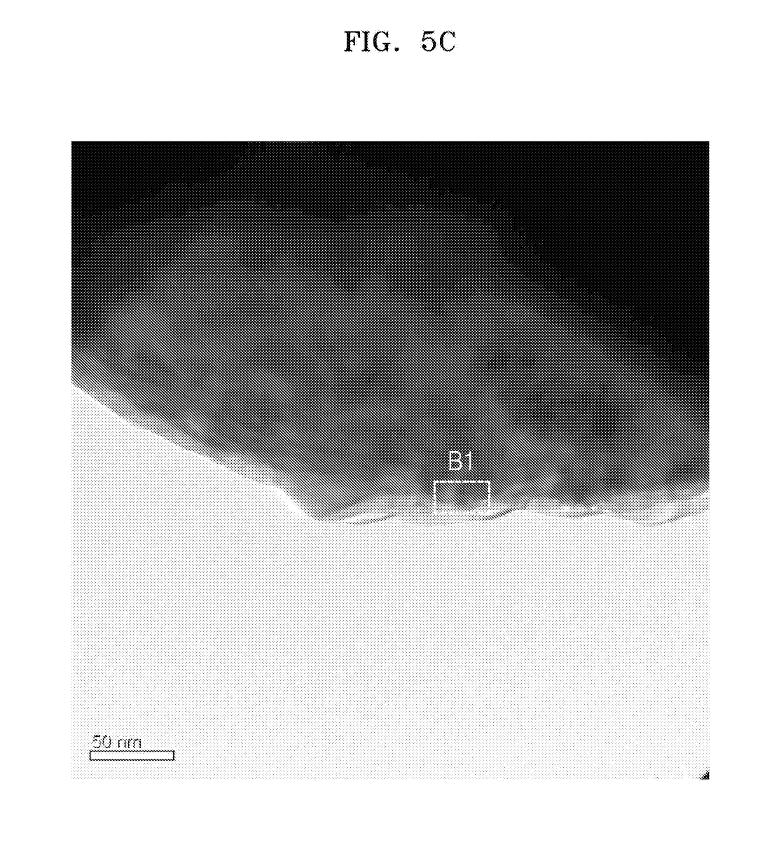

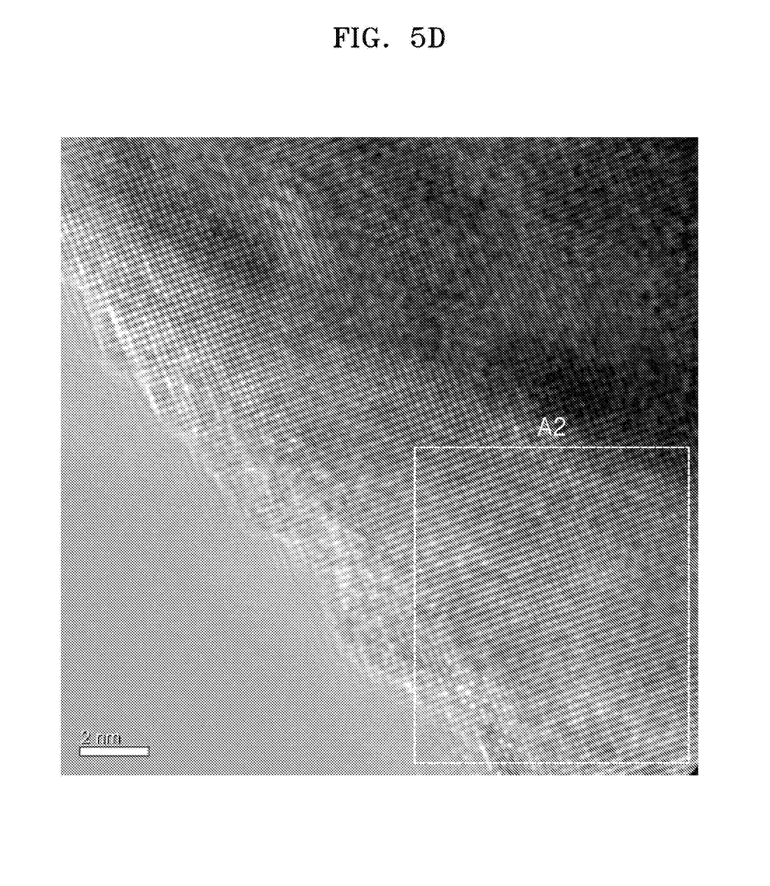

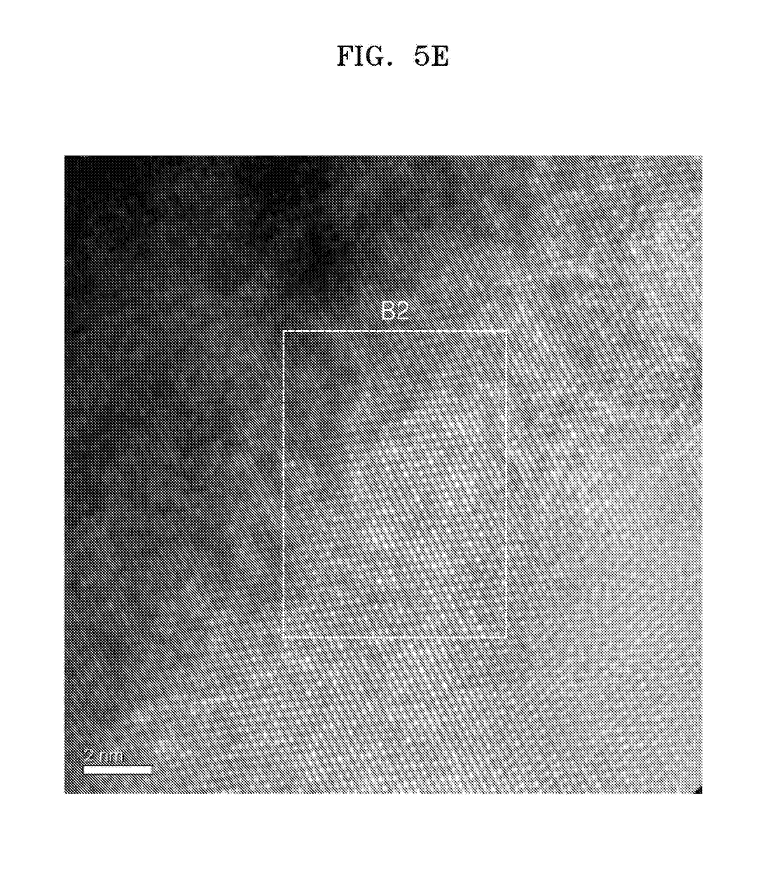

The positive electrode active material prepared in Preparation Example 7 was analyzed by using a transmission electron microscope (Tecnai, FEI, U.S.A.). Transmission electron microscope analysis images are shown in FIGS. 5A-G. FIGS. 5B and 5C are enlarged images of area A and area B in FIG. 5A, respectively. FIGS. 5D and 5E are enlarged images of area A1 in FIG. 5B and area B1 in FIG. 5C, respectively. FIGS. 5F (ZA=[−441]_{Rhombohedral}) and 5G (ZA=[013]_{cubic}) are transformed images of area A2 in FIG. 5D and area B2 in FIG. 5E by using a Fast Fourier Transform (FFT), respectively. By referring to the images, when transforming by using the FFT and indexing a high-resolution image taken from a surface of the positive electrode active material, it was found that the positive electrode active material has a rhombohedral phase just as does lithium nickel cobalt manganese oxide.

### EVALUATION EXAMPLE 3

### Energy Dispersive X-Ray Spectroscopy (EDS) Analysis

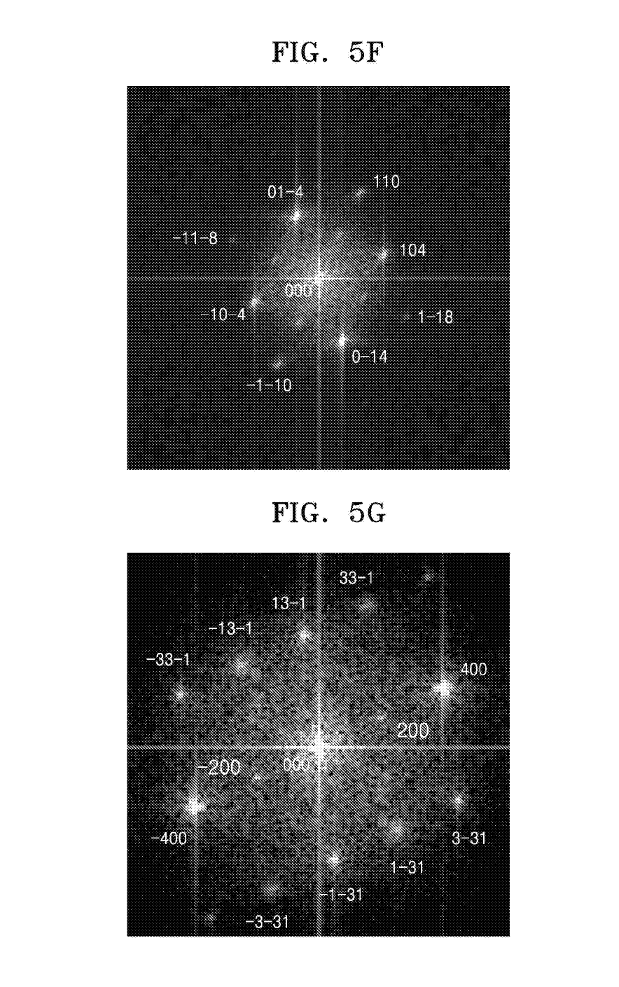

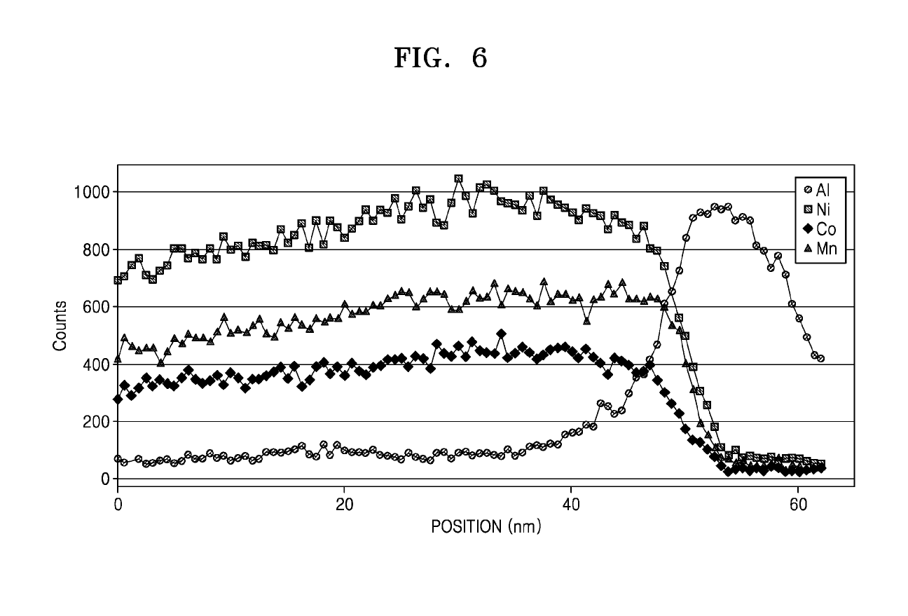

An EDS analysis was performed on the positive electrode active material prepared in Preparation Example 7. The results are shown in FIG. 6.

Referring to FIG. 6, it was found that the positive electrode active material prepared in Preparation Example 7 contained aluminum therein as well as in the coating film having a thickness of about 10 nm or less.

### EVALUATION EXAMPLE 4

### Electron Energy Loss Spectroscopy (EELS) Analysis

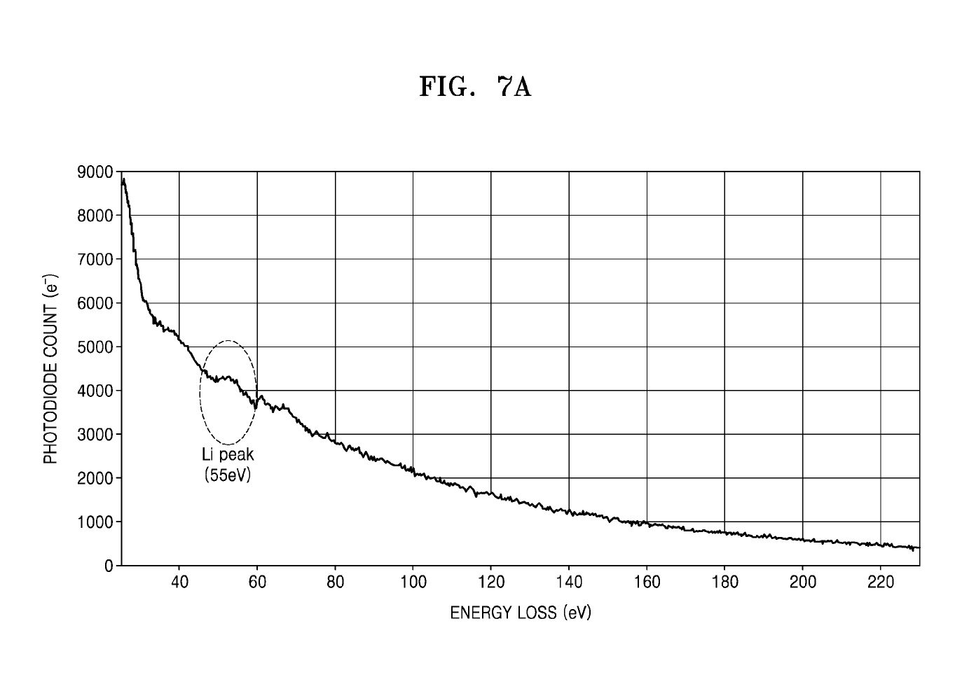

An EELS analysis was performed on the positive electrode active material prepared in Preparation Example 7. The results thereof are shown in FIGS. 7A and 7B.

Referring to FIGS. 7A and 7B, it was found that the coating film of the positive electrode active material contained a phase having lithium, aluminum, and oxide and in a rhombohedral phase.

### EVALUATION EXAMPLE 5

### XRD Analysis

An XRD analysis was performed on the positive electrode active material prepared in Preparation Examples 4 and 8 and Comparative Preparation Example 4. The results of XRD analysis are provided below in Table 1.

TABLE 1

| | FWHD (110 face) (°) | FWHD (116 face) (°) |
|---|---|---|
| Preparation Example 4 | 0.143 | 0.117 |
| Preparation Example 8 | 0.139 | 0.114 |
| (LiAlO₂) | | |
| Comparative Preparation | 0.144 | 0.118 |
| Example 4 | | |

By referring to Table 1, it was found that FWHMs of a (110) face and (116) face of the positive electrode active materials prepared in Preparation Examples 4 and 8 are smaller than the FWHM of a (110) face and (116) face of the positive electrode active material prepared in Comparative Preparation Example 4. By referring to the results above, it was found that the positive electrode active material prepared in Preparation Examples 4 and 8 had a high degree of crystallinity, compared to the positive electrode active material prepared in Comparative Preparation Example 4.

### EVALUATION EXAMPLE 6

### X-Ray Photon Spectroscopy (XPS)

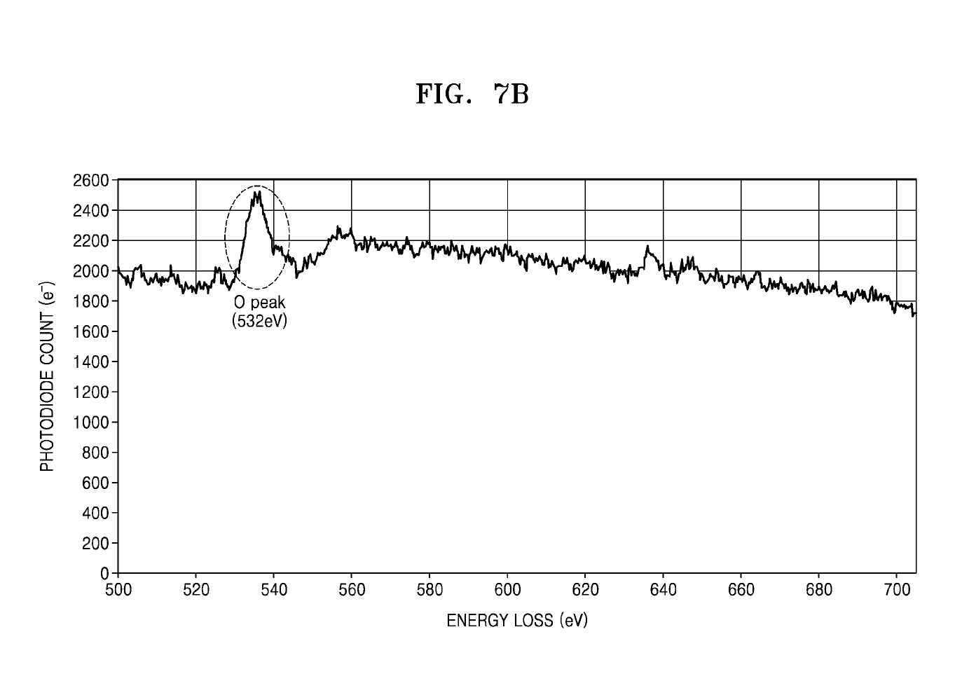

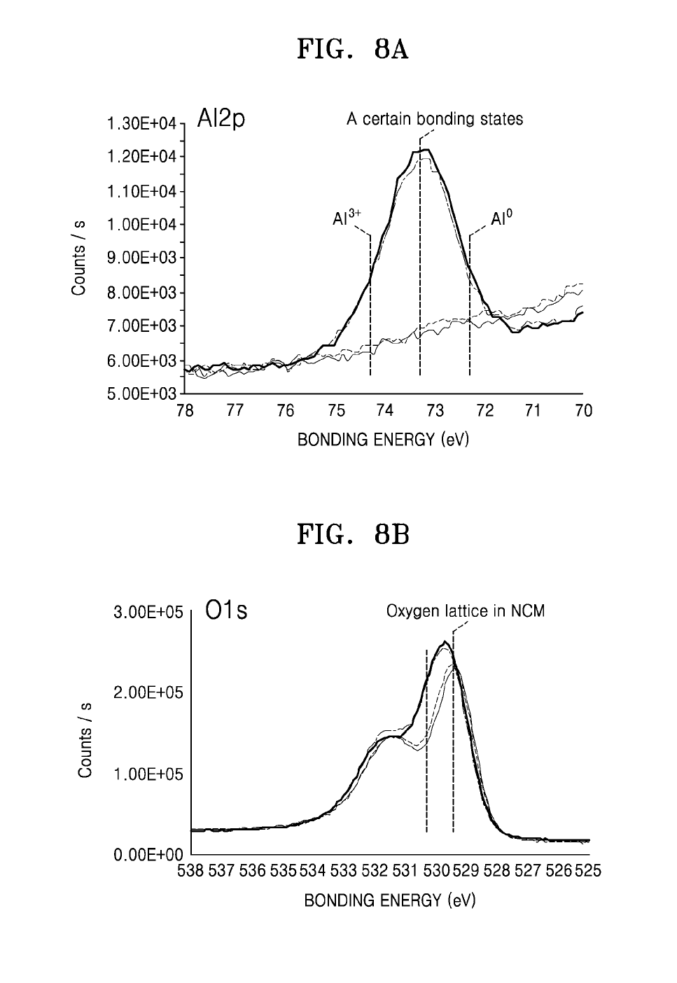

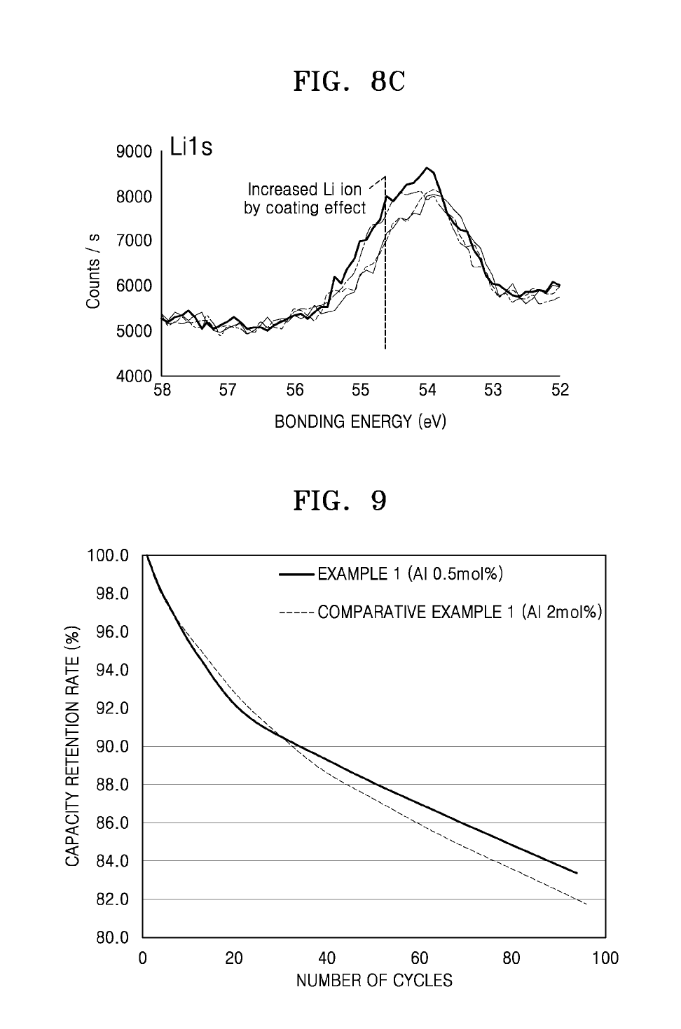

An XPS analysis was performed on the positive electrode active materials prepared in Preparation Examples 1 and 7 and Comparative Preparation Examples 1 and 3. The XPS analysis results are shown in FIGS. 8A to 8C.

By referring to FIGS. 8A to 8C, it was found that the coating film formed on a surface of the positive electrode active material contains lithium aluminate (LiAlO₂).

### EVALUATION EXAMPLE 7

### Lifespan Test at High Temperature

Charge and discharge characteristics of the coin cells prepared in Example 1 and Comparative Example 1 were evaluated by using a charge and discharge test system (available from: TOYO, Model No.: TOYO-3100), and the results are shown in FIG. 9.

Each of the coin cells prepared in Examples 1 and Comparative Example 1 was subjected to one cycle of charging and discharging at a rate of 0.2 C to perform a formation and one cycle of charging and discharging at a rate of 0.2 C at 45° C. to identify initial charge and discharge characteristics. Charging and discharging at a rate of 0.2 C were repeated 100 times to evaluate cycle characteristics. The charging was initiated in a constant current (CC) mode, continued in a constant voltage (CV) mode, and cut off at 4.4 V, and the discharging was performed in a CC mode and cut off at 3 V.

Referring to FIG. 9, it was found that at 45° C., the coin cell prepared in Example 1 unexpectedly had improved lifespan characteristics compared to the coin cell prepared in Comparative Example 1.

### EVALUATION EXAMPLE 8

### Lifespan Test

1) Evaluation Carried Out at Room Temperature (25° C.).

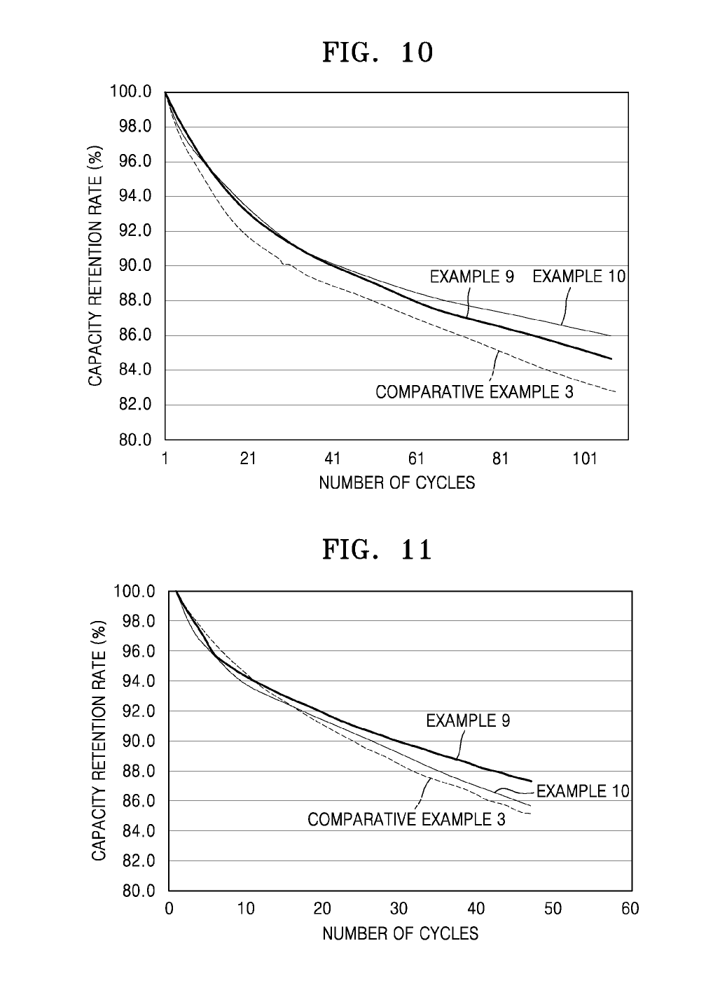

Each of the coin cells prepared in Examples 9 and 10 and Comparative Example 3 was subjected to one cycle of charging and discharging at a rate of 0.1 C to perform a formation and one cycle of charging and discharging at a rate of 0.2 C to identify charge and discharge characteristics using the above instrument of Example 7. The results thereof are shown in Table 2 and FIG. 10.

The charging and discharging was performed at 25° C. The charging was initiated in a CC mode, continued in a CV mode, and cut off at 4.4 V, and the discharging was performed in a CC mode and cut off at 3 V.

The charging capacity and discharging capacity in Table 2 refer to a charging capacity and discharging capacity measured during the first cycle, respectively.

TABLE 2

| Compositions of | Standard capacity (0.2 C/0.2 C) | | |
|---|---|---|---|
| positive electrode | Charging | Discharging | Efficiency |
| active materials | capacity (mAh/g) | capacity (mAh/g) | (%) |
| Example 9 | 164.5 | 160.8 | 97.7 |
| Example 10 | 161.5 | 157.3 | 97.4 |
| Comparative | 164.4 | 160.3 | 97.4 |
| Example 3 | | | |

Referring to Table 2 and FIG. 10, it was found that the lithium secondary batteries prepared in Examples 9 and 10, though their positive electrode active materials are doped with Al, have excellent charging and discharging efficiency compared to the lithium secondary battery prepared in Comparative Example 3.

2) Evaluation Carried Out at High Temperature (45° C.)

The coin cells prepared in Examples 9 and 10 and Comparative Example 3 were analyzed as follows to identify lifespan characteristics thereof at a high temperature:

Each of the coin cells was subjected to one cycle of charging and discharging at a rate of 0.1 C to perform a formation and one cycle of charging and discharging at a rate of 0.2 C to identify charge and discharge characteristics. The results thereof are shown in FIG. 11.

The charging and discharging was performed at 45° C. The charging was initiated in a CC mode, continued in a CV mode, and cut off at 4.4 V, and the discharging was performed in a CC mode and cut off at 3 V.

Referring to FIG. 11, it was found that at a high temperature, the coin cells prepared in Examples 9 and 10 had improved lifespan characteristics, compared to the coin cell prepared in Comparative Example 3.

### EVALUATION EXAMPLE 9

### Rate Capability

Each of the coin cells prepared in Examples 3, 4, and 11 and Comparative Example 2 was subjected to one cycle of charging and discharging at a rate of 0.1 C to perform a formation, and then one cycle of charging and discharging at rates of 0.1 C and 1 C, respectively.

The charging was initiated in a CC mode, continued in a CV mode, and cut off at 4.3 V, and the discharging was performed in a CC mode and cut off at 2.75 V.

As described above, charging and discharging were performed, and expressed as a percentile of discharge capacity at a rate of 1 C based on the discharge capacity at a rate of 0.1 C. The results thereof are shown in Table 3.

TABLE 3

| | 0.1 C | | 1.0 C | 1 C/0.1 C |
|---|---|---|---|---|
| | Charging | Discharging | Discharging | High rate |
| | capacity | capacity | capacity | capability |
| | (mAh/g) | (mAh/g) | (mAh/g) | (%) |
| Example 3 | 214.3 | 189.4 | 171.0 | 90.3 |
| (Li_{1.05}Ni_{0.5}Co_{0.2}Mn_{0.295}Al_{0.005}O₂) | | | | |
| Example 4 | 214.2 | 190.3 | 171.9 | 90.3 |
| (Li_{1.05}Ni_{0.5}Co_{0.2}Mn_{0.295}Al_{0.005}O₂) | | | | |
| Example 11 | 214.4 | 188.7 | 170.5 | 90.4 |
| (Li_{1.05}Ni_{0.5}Co_{0.2}Mn_{0.29}Al_{0.01}O₂) | | | | |
| Comparative Example 2 | 212.2 | 185.9 | 168.5 | 90.6 |
| (Li_{1.05}Ni_{0.50}Co_{0.20}Mn_{0.28}Al_{0.02}O₂) | | | | |

Referring to Table 3, it can be seen that the coin cells prepared in Examples 3, 4, and 11 had unexpectedly improved capacity characteristics when compared to the coin cell prepared in Comparative Example 2. The coin cell prepared in Example 4 had the most excellent capacity characteristics among others. In addition, it was found that the coin cells prepared in Examples 3, 4, and 11 had approximately the same high rate capability when compared to the coin cell prepared in Comparative Example 2.

### EVALUATION EXAMPLE 10

### Analysis Using Differential Scanning Calorimeter

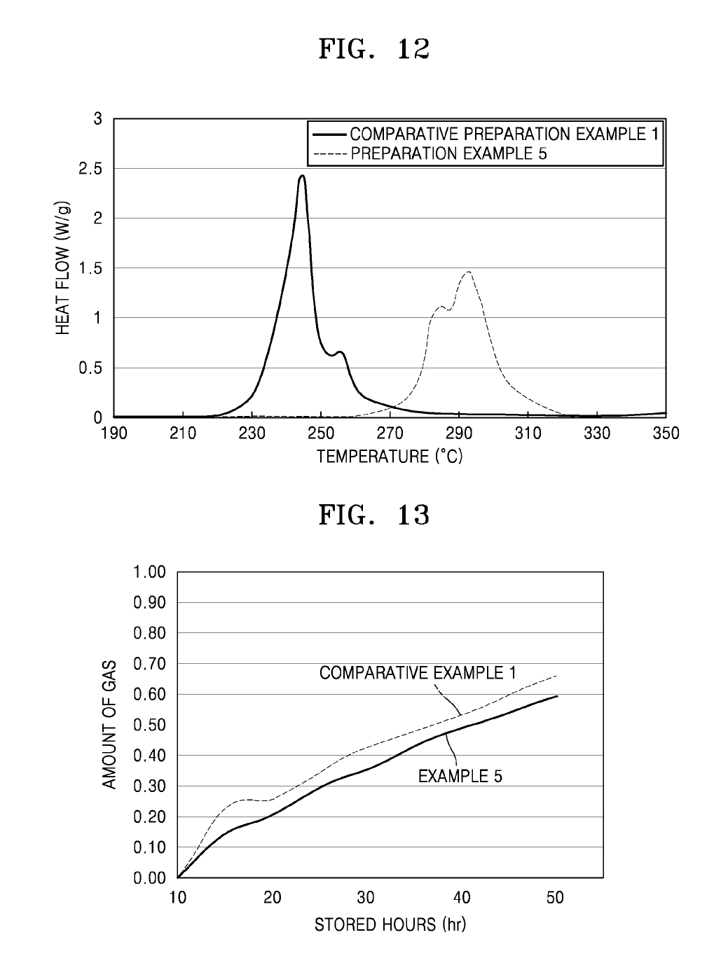

Thermal stabilities of the lithium composite oxide prepared in Preparation Example 5 and Comparative Preparation Example 1 were evaluated by using a differential scanning calorimeter (DSC). The results are shown in FIG. 12.

Referring to FIG. 12, the lithium composite oxide prepared in Preparation Example 5 exhibited unexpectedly improved thermal stability when compared to the lithium composite oxide prepared in Comparative Preparation Example 1. Thus, the lithium composite oxide prepared in Preparation Example 5 unexpectedly had improved stability when compared to the lithium composite oxide prepared in Comparative Preparation Example 1.

### EVALUATION EXAMPLE 11

### Gas Emission Amount Test

The coin cells prepared in Example 5 and Comparative Example 1 were disassembled, and then the positive electrode was sealed in an aluminum pouch with the electrolyte.

The sealed electrode was stored at about 80° C. for about 40 hours. Then, the amount of emitted gas over time was measured. The results thereof are shown in FIG. 13.

Referring to FIG. 13, it was confirmed that the coin cell prepared in Example 5 unexpectedly had a less amount of gas emission than the coin cell prepared in Comparative Example 1.

### EVALUATION EXAMPLE 12

### Lifespan Test at High Temperature

1) Example 5, Comparative Example 1, and Comparative Example 5

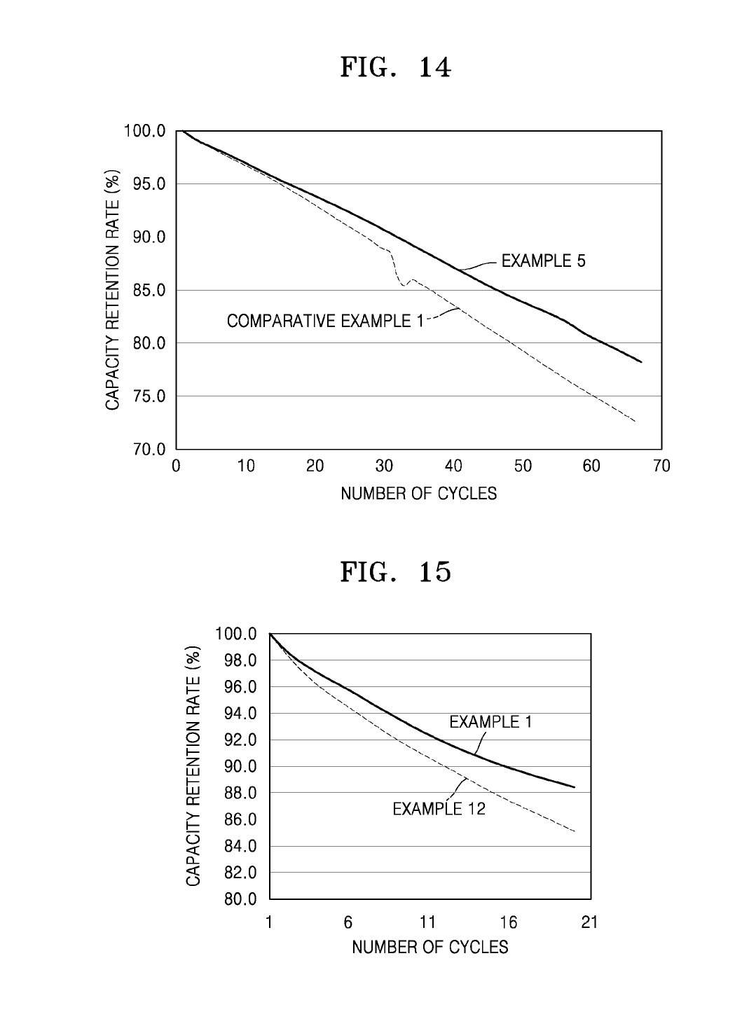

Each of the coin cells prepared in Example 5 and Comparative Examples 1 and 5 was subjected to one cycle of charging and discharging at a rate of 0.1 C to perform a formation and one cycle of charging and discharging at a rate of 0.2 C to identify charge and discharge characteristics. The results thereof are shown in FIG. 14.

The charging and discharging was performed at 45° C. The charging was initiated in a CC mode at a rate of 0.7 C, continued in a CV mode, and cut off at 4.4 V, and the discharging was performed in a CC mode at a rate of 0.5 C and cut off at 3 V.

Referring to FIG. 14, it was found that at a high temperature, the coin cell prepared in Example 5 unexpectedly had improved lifespan characteristics when compared to the coin cell prepared in Comparative Example 1.

In addition, the coin cell prepared in Comparative Example 5 exhibited a similar level of lifespan characteristics at a high temperature with the coin cell prepared in Comparative Example 1.

2) Example 1 and Example 12

Each of the coin cells prepared in Examples 1 and 12 was subjected to one cycle of charging and discharging at a rate of 0.1 C to perform a formation and one cycle of charging and discharging at a rate of 0.2 C to identify charge and discharge characteristics. The results thereof are shown in FIG. 15.

The charging and discharging was performed at 45° C. The charging was initiated in a CC mode at a rate of 0.7 C, continued in a CV mode, and cut off at 4.4 V, and the discharging was performed in a CC mode at a rate of 0.5 C and cut off at 3 V.

Referring to FIG. 15, it was found that at a high temperature, the coin cell prepared in Example 1 unexpectedly had improved lifespan characteristics when compared to the coin cell prepared in Example 12.

### EVALUATION EXAMPLE 13

### Charging and Discharging

Each of the coin cells prepared in Examples 1 and 12 was subjected to one cycle of charging and discharging at a rate of 0.1 C to perform a formation and one cycle of charging and discharging at a rate of 0.2 C to identify charge and discharge characteristics. The results thereof are shown in FIG. 14.

The charging and discharging was performed at 25° C. The charging was initiated in a CC mode at a rate of 2 C, continued in a CV mode, and cut off at 4.4 V, and the discharging was performed in a CC mode at a rate of 2 C and cut off at 3 V.

Once the formation and charging and discharging were complete, efficiencies thereof are calculated. The results thereof are shown in Table 4.

TABLE 4

| | Formation capacity (0.1 C/0.1 C) | | | Standard capacity (0.2 C/0.2 C) | | |
|---|---|---|---|---|---|---|
| | Charging | Discharging | | Charging | Discharging | |
| | capacity | capacity | | capacity | capacity | |
| | (mAh/g) | (mAh/g) | Efficiency | (mAh/g) | (mAh/g) | Efficiency |
| Example 1 (γ-Al₂O₃ 0.5 mol %) | 209.5 | 175.1 | 83.6 | 174.5 | 172.8 | 99.0 |
| Example 12 (γ-Al₂O₃ 0.5 mol %) | 208.4 | 174.4 | 83.7 | 174.1 | 171.1 | 98.2 |

Referring to Table 4, it was found that the coin cell prepared in Example 1 unexpectedly had improved discharging efficiency, compared to the coin cell prepared in Example 12.

As described above, according to the one or more of the above exemplary embodiments, the positive electrode active material has an improved electrochemical stability at a high charging voltage. When employing a positive electrode containing the lithium composite oxide, the lithium secondary battery may have an improved lifespan and charge and discharge characteristics.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

In the present disclosure, the terms “Preparation Example,” “Comparative Preparation Example,” “Comparative Example,” and “Evaluation Example” are used arbitrarily to simply identify a particular example or experimentation and should not be interpreted as admission of prior art. While one or more exemplary embodiments have been described with reference to the figures, it will be understood by those of ordinary skill in the art that various changes in form and details may be made therein without departing from the spirit and scope as defined by the following claims.

What is claimed is:

1. A positive electrode active material, comprising a lithium composite oxide represented by Formula 1:
LiₐNiₓCo_{y}M_{1-x-y-z}Al_{z}O₂ [Formula 1]
wherein in Formula 1, M is at least one metal selected from manganese (Mn), magnesium (Mg), chromium (Cr), iron (Fe), titanium (Ti), zirconium (Zr), molybdenum (Mo), aluminum (Al), silicon (Si), and zinc (Zn);
1≦a≦1.3;
x is a number in a range of about 0.45 to about 0.6;
y is a number in a range of about 0.15 to about 0.3; and
z is a number in a range of about 0.003 to about 0.01.

2. The positive electrode active material of claim 1, wherein M is Mn.

3. The positive electrode active material of claim 1, wherein in Formula 1, Z is a number in a range of about 0.005 to about 0.001.

4. The positive electrode active material of claim 1, wherein the lithium composite oxide is Li_{1.05}Ni_{0.55}Co_{0.25}Mn_{0.195}Al_{0.005}O₂, Li_{1.05}Ni_{0.55}Co_{0.25}Mn_{0.19}Al_{0.01}O₂, Li_{1.05}Ni_{0.5}Co_{0.2}Mn_{0.295}Al_{0.005}O₂, or Li_{1.05}Ni_{0.5}Co_{0.2}Mn_{0.29}Al_{0.01}O₂.

5. The positive electrode active material of claim 1, wherein an average particle diameter of primary particles of the lithium composite oxide is in a range of about 0.5 μm to about 2.0 μm.

6. The positive electrode active material of claim 1, further comprising a coating film comprising lithium aluminate (LiAlO₂).

7. The positive electrode active material of claim 5, wherein an amount of the LiAlO₂ is in a range of about 0.1 part by weight to about 30 parts by weight based on 100 parts by weight of the lithium composite oxide represented by Formula 1.

8. A method of preparing a positive electrode active material comprising the lithium composite oxide represented by Formula 1, the method comprising adding aluminum oxide and lithium carbonate to a compound represented by Formula 2 and heat-treating at about 900° C. to about 950° C.:
LiₐNiₓCo_{y}M_{1-x-y-z}Al_{z}O₂ [Formula 1]
wherein in Formula 1, M is at least one metal selected from Mn, Mg, Cr, Fe, Ti, Zr, Mo, Al, Si, and Zn;
1≦a≦1.3,
x is a number in a range of about 0.45 to about 0.6;
y is a number in a range of about 0.15 to about 0.3; and
z is a number in a range of about 0.003 to about 0.01,
NiₓCO_{y}M_{1-x-y-z}Al_{z}(OH)₂ [Formula 2]
wherein in Formula 2, M is at least one metal selected from Mn, Mg, Cr, Fe, Ti, Zr, Mo, Al, Si, and Zn;
x is a number in a range of about 0.45 to about 0.6;
y is a number in a range of about 0.15 to about 0.3; and
z is a number in a range of about 0.003 to about 0.01,
wherein M in Formulas 1 and 2 are the same.

9. A lithium secondary battery comprising a positive electrode comprising the positive electrode active material in claim 1; a negative electrode; and electrolyte disposed between the positive electrode and negative electrode.

10. The lithium secondary battery of claim 9, wherein the charging voltage of the lithium secondary battery is in a range of about 2.8 V to about 4.5 V.

11. A lithium secondary battery of claim 9, further comprising the positive electrode active material wherein M is Mn.

12. A lithium secondary battery of claim 9, further comprising the positive electrode active material wherein the lithium composite oxide is Li_{1.05}Ni_{0.55}Co_{0.25}Mn_{0.195}Al_{0.005}O₂, Li_{1.05}Ni_{0.55}Co_{0.25}Mn_{0.19}Al_{0.01}O₂, Li_{1.05}Ni_{0.5}Co_{0.2}Mn_{0.295}Al_{0.005}O₂, or Li_{1.05}Ni_{0.5}Co_{0.2}Mn_{0.29}Al_{0.01}O₂.

13. A lithium secondary battery of claim 9, further comprising the positive electrode active material wherein an average particle diameter of primary particles of the lithium composite oxide is in a range of about 0.5 μm to about 2.0 μm.

14. A lithium secondary battery of claim 9, further comprising the positive electrode active material comprising a coating film comprising lithium aluminate (LiAlO₂).

15. A lithium secondary battery of claim 9, further comprising the positive electrode active material wherein an amount of the LiAlO₂ is in a range of about 0.1 part by weight to about 30 parts by weight based on 100 parts by weight of the lithium composite oxide represented by Formula 1.
